(19) United States
(12) Patent Application Publication
(10) Pub. No.: US 2007/0074282 A1
(43) Pub. Date: Mar. 29, 2007

(54) Distributed SSL processing

(76) Inventors: Jeffrey T. Black, Boston, MA (US); Kwok C. Lee, Woburn, MA (US); Myron Zimmerman, Needham, MA (US)

Correspondence Address: GOODWIN PROCTER LLP;PATENT ADMINISTRATOR, EXCHANGE PLACE, BOSTON, MA, 02109-2881, US

(21) Appl. No.: 11/506,403

(22) Filed: Aug. 18, 2006

Related U.S. Application Data
(60) Provisional application No. 60/709,641, filed on Aug. 19, 2005.

(51) Int. Cl. G06F 15/16

(52) U.S. Cl. 726/14

(57) ABSTRACT

Methods and systems for communicating data between a server and a remote client computer through a secure socket layer (“SSL”). In accordance with the present invention, server-side SSL functions are performed by a network device located remotely from a secure data center, while maintaining the secure use of centralized certificates and their associated private keys. The invention may be employed in conjunction with acceleration functions operating within coordinated network devices, facilitating acceleration of overall SSL traffic. The invention improves on the prior art by allowing the remotely located acceleration device to use the certificate and private key of the target application server, but without compromising the security of the server's private key.

### CROSS-REFERENCE TO RELATED CASES

This application claims the benefit of U.S. Provisional Patent Application No. 60/709,641, filed on Aug. 19, 2005, which is hereby incorporated by reference as if set forth herein in its entirety.

### FIELD OF THE INVENTION

This invention relates to a method and system for communicating data and, more particularly, to a method and system for communicating data between a server and a remote client computer through a secure socket layer (“SSL”) connection.

### BACKGROUND OF THE INVENTION

Communication Security

The use of data networks today increasingly mandates secure communication between a client's computer and a server computer. Situations in which, for example, a customer interacts with a banking software application over the Internet to pay bills or transfer funds between accounts, or engages in on-line shopping using a credit card, require confidence in the security of the data transmitted. Even within closed networks such as an enterprise's intranet, administrators often require that sessions between browsers and mission-critical application servers be carried out over secure connections to minimize the chance of unauthorized data access.

A secure connection typically requires two criteria: authentication and encryption. Authentication refers to a mechanism whereby one party in an end-to-end communications session can positively verify the identity of the other. Such a mechanism prevents, for example, a server running malicious software from masquerading as a trustworthy server and collecting an unwitting consumer's credit card information. Authentication of clients may be performed by server-based software to prevent the disclosure of sensitive information to unauthorized persons.

To thwart eavesdropping between properly authenticated machines, the information flow between a client and a server is encrypted. Encryption typically involves the use of numerical keys which are known to the sender and receiver. These keys are used to generate pseudo-random numerical sequences with specific cryptographic algorithms which, in combination with input data, generate encrypted data suitable for transmission. Without the keys, eavesdroppers cannot decipher the encrypted data passing between the client and the server. Much research has been done in the development of currently available cryptographic algorithms.

In recent years, SSL has become a widely-adopted technology for facilitating secure communications between client and server computers. SSL utilizes both symmetric and asymmetric cryptographic techniques. Symmetric cryptography refers to techniques where the same key is used for both encryption and decryption. In contrast, asymmetric methods such as public key cryptography use different keys for encrypting data and decrypting data. In SSL, public key cryptography is generally used to initialize a secure session between client and server computers. Following session initialization, symmetric cryptography is used to encrypt and decrypt session data passing between them.

During SSL session initialization, the client and server computers exchange ‘hello’ messages by which they negotiate the SSL version, a session identifier, and the cipher suite specifying the cryptographic and key exchange algorithms. They also exchange random numbers for use in generating various session-specific keys. Optionally, a certificate may also be sent by either side in order to authenticate its identity to the other. The certificate is a data object (formatted according to a well-known standard such as ANSI X.509) that contains various information including the identity of the sender. Depending on use, the identity may be a user or computer name, a serial number, a fully qualified domain name, or some other identifier. The certificate also contains the public key of the sender as well as the identity of a certificate authority (CA) that issued the certificate. Because the purpose of the certificate is to verify the identity of the sender, the certificate should itself be verifiable. This may be accomplished by having the certificate generated and issued by a trusted CA, one known or approved of by the receiver of the certificate, such as VeriSign, Inc. The CA may also be a trusted service running within an enterprise's network.

SSL also allows for the chaining of intermediate certificates and CAs back to a well-known CA for final verification. In generating the certificate, the CA “signs” it by including an MD5 or similar digest of the certificate's contents and encrypting this digest with its own private key. During SSL session initialization, the certificate can then verified by a receiver by decrypting the “signature” using the CA's public key and validating it against the certificate's computed digest.

At this point in session initialization, basic parameters have been negotiated, one or both sides have been authenticated, public key(s) have been exchanged, and seed material for session-specific keys has been exchanged in the form of client- and server-generated random numbers. The last step prior to data transfer is to generate and exchange a “pre-master” key from which various session-specific keys are derived. This is typically accomplished by having the client generate a random number (the pre-master key), encrypt the number with the server's public key (from the server's certificate), and send the encrypted pre-master key to the server in the form of a client key exchange message. The server then decrypts the pre-master key using its own private key. The client and server sides, both now in possession of the common pre-master key, can use it to derive common session-specific keys, including client and server message authentication keys, data (write) keys, and optionally, initialization vectors. It is these keys that both sides use in conjunction with the negotiated cryptographic algorithm to encrypt and decrypt session data. Because the same keys are used for both encryption and decryption, this phase of an SSL session uses symmetric cryptography.

SSL Offload

Cryptography in general, and public key cryptography in particular, generally requires significant computing resources. This demand is particularly acute in centralized computing environments where application servers must initialize and maintain secure sessions with hundreds or thousands of clients simultaneously. For this reason, recent years have seen the emergence of dedicated network devices whose purpose is to relieve application servers of SSL functions. As shown in FIG. 1, these devices 116 typically occupy a secure location within the centralized data center 112, along with the application servers 120, 120′, 120″ themselves. These devices 116 act as proxies, intercepting incoming SSL session traffic from clients 100, 100′, 100″, performing server-side SSL functions on behalf of the application servers 120, 120′, 120″, and passing non-SSL (i.e., clear) traffic to and from the application servers 120, 120′, 120″. Because the application servers 120, 120′,120″ do not perform the SSL functions themselves, their computational burdens are greatly reduced. It should be noted that dedicated SSL offload devices 116 generally have specialized cryptographic hardware that allows for higher performance than generalized servers performing software-based cryptography.

This centralized approach for SSL offload is especially feasible when the offload devices 116 are co-located with the application servers 120, 120′, 120″ inside secure data centers 112, in which case clear traffic is permissible between them and the application servers 120, 120′, 120″. Furthermore, the certificates authenticating the application servers 120, 120′, 120″, and their corresponding private keys, can be safely installed on the offload devices 116—a requirement for terminating the SSL connections 108 from clients 100, 100′, 100″. Because the devices 116 can securely utilize the application servers'certificates for authentication to clients 100, 100′, 100″, administrators are not burdened with maintaining additional certificates for the SSL offload devices 116 themselves, and the SSL offload function remains transparent to clients 100, 100′, 100″.

Application Acceleration and SSL

In recent years, vendors have developed network devices whose purpose is to accelerate the performance of software applications running over a wide area network (“WAN”). While these devices can undertake a number of network-related functions, they typically perform one or more techniques for data reduction, including but not limited to packet-level data compression, caching, and object differencing.

As shown in FIG. 2, such acceleration devices 208, 232 are typically deployed in enterprise networks for the purpose of accelerating traffic between client (e.g., employee) computers 200, 200′, 200″ located in a remote office 204, and servers 240, 240′, 240″ located in a central data center 228. The acceleration devices 208, 232 inspect the traffic and perform data reduction on the data contained therein. However, as shown in FIG. 2, the presence of SSL in such a system inhibits the acceleration devices'208, 232 ability to reduce traffic data. This is because encryption of the SSL session traffic not only obfuscates the data, but also effectively randomizes it as well. Random data is theoretically incompressible because it contains no redundant information.

One possible solution to the problem of accelerating SSL session traffic is to distribute the server-side SSL termination point (otherwise located in the SSL offload device in the data center) out to the remote office. As shown in FIG. 3, an acceleration device 308, performing the functions of SSL termination 312, acceleration 316, and Virtual Private Network (VPN) 320, resides at a remote office location 304. A second acceleration device 348, containing the functions of VPN 352 and acceleration 356, resides at a data center location 344. In such a system, the remote office acceleration device 308 performs the server-side SSL function, thereby terminating the SSL connection 324 from the client 300, 300′, 300″ locally. Having terminated the SSL connection 324, the device 308 can effectively accelerate the non-encrypted traffic. Because security remains a requirement in managing traffic between the remote office and data center, the acceleration device 308 may also contain a VPN function 320 which, among other things, performs encryption and decryption of accelerated traffic 332 traversing the WAN 340. The acceleration device 348 located in the data center 344 performs the corresponding functions of acceleration 356 and VPN 352 as it processes traffic 328 to and from the remote office acceleration device 308.

In implementing this SSL acceleration system, the matter of authenticating the remote office acceleration device during SSL session initialization must still be resolved. More specifically, if the device terminates a client-initiated SSL session on behalf of the target application server, what certificate should it use and how should the corresponding private key be managed:

1. Installation of Server Certificates and Keys. This method simply calls for the installation of application server certificates and their corresponding private keys onto the remote acceleration devices, in a manner similar to their installation on the centralized SSL offload devices shown in FIG. 1. However, unlike centralized data center devices, the remote acceleration devices are generally located in environments with minimal network or physical security. Therefore, this technique jeopardizes the security of server private keys and thus is generally considered unacceptable.

2. Installation of Authenticated Certificates and Keys. This method calls for the issuance and installation of (new) authenticated certificates and their corresponding private keys onto each of the individual remote acceleration devices. Application server certificates and keys are not used for authentication and thus can remain securely in the data center. While this method maintains an acceptable level of security, it carries a significant management burden. Specifically, administrators have to manage the issuance, installation, and ongoing maintenance of certificates for all such remote devices. If a commercial CA is used, recurring costs may also be appreciable, particularly where large numbers of device certificates are necessary.

3. Installation of Non-authenticated Certificates and Keys. This is a simplified method in which each remote device uses a certificate (perhaps even one assigned at manufacturing time) that cannot be authenticated by a trusted CA. While this greatly reduces management complexity and cost, it weakens overall system security. Specifically, in order to make an SSL connection (with a remote acceleration device performing SSL termination on behalf of an application server), the client will have to explicitly trust the identity of the acceleration device, since its certificate cannot be authenticated by a trusted CA. This is usually done via a pop up window from the client's web browser. Requiring the client to trust an unauthenticated device or computer is generally considered an unacceptable security risk.

Accordingly, a need exists for improved authentication techniques that accommodate remote acceleration devices.

### SUMMARY OF THE INVENTION

In accordance with the present invention, server-side SSL functions are performed by a network device located remotely from a secure data center, while maintaining the secure use of centralized certificates and their associated private keys. The invention may be employed in conjunction with acceleration functions operating within coordinated network devices, facilitating acceleration of overall SSL traffic. Embodiments of the invention allow the remotely located acceleration device to use the certificate and private key of the target application server without compromising the security of the server's private key. In employing the invention, system administrators can reduce certificate management complexity and cost while maintaining an adequate level of security.

In one embodiment, the server-side SSL function is partitioned into two discrete functions: the SSL Certificate Manager, and the SSL Server Proxy. The SSL Certificate Manager is contained within a network device typically located within a secure data center. Its purpose is to maintain certificates and their associated private keys, and to pass requested certificates to, and service decryption requests from, one or more remote SSL Server Proxies during SSL session initialization. The SSL Server Proxy may be located in an insecure remote office location. It acts as the server side of an SSL connection on behalf of the intended target application server. During SSL session initialization the SSL Server Proxy performs SSL Hello, Certificate, KeyExchange, and Finish message processing according to the SSL specification. The SSL Server Proxy does not maintain permanently stored certificates and does not have access to the private keys associated with those certificates. For these reasons, during SSL session initialization, the SSL Server Proxy makes requests to the SSL Certificate Manager for certificates and decryption operations utilizing their private keys. Following session initialization, the SSL Server Proxy performs encryption and decryption of session traffic without further involvement from the SSL Certificate Manager.

In a first aspect, a method of securely communicating data between a server and a remote client computer includes providing an SSL server proxy and a certificate manager comprising a decryption facility. An SSL connection is established between the client computer and the server utilizing communications between the SSL server proxy and the certificate manager. The SSL server proxy is then used to conduct a SSL communication session between the client computer and the server.

In some embodiments, the SSL server proxy decrypts client-originated messages to the server, or encrypts server-originated messages to the client. Decryption and encryption by the SSL server proxy may occur without further involvement from the certificate manager. In some embodiments, the decryption facility may utilize a key and the key may be a private key. If the key is a private key, the certificate manager performs all operations using the private key so as to exclude the client computer and the SSL server proxy from access to it. In one embodiment, the SSL server proxy is co-located with the client computer. Moreover, the method may further comprise causing the SSL server proxy to terminate the SSL connection with the client computer and performing data reduction on unencrypted data traffic outside the SSL connection. In this case, the reduced data traffic may be exchanged via a virtual private network.

In another aspect, a system for facilitating secure communication of data between a server and a remote client computer comprises a certificate manager having a decryption facility; a secure socket (SSL) server proxy; a connector for establishing a SSL connection between the client computer and the server via the SSL server proxy and the certificate manager using the decryption facility; and a transceiver for conducting a SSL communication session between the client computer and the server via the SSL server proxy.

In some embodiments, the SSL server proxy may decrypt client-originated messages to the server, or encrypt server-originated messages to the client. The SSL server proxy may decrypt or encrypt without further involvement from the certificate manager. Moreover, the decryption facility may be a key. In some embodiments, this key is a private key, and the certificate manager performs all operations using the private key so as to exclude the client computer and the SSL proxy from access to it. The SSL server proxy may be co-located with the client computer. The system may also further comprise an accelerator that causes the SSL server proxy to terminate the SSL connection to the client computer, and performs data reduction on the unencrypted data traffic outside the SSL connection. In such systems with an accelerator, the reduced data traffic may be exchanged via a virtual private network.

### BRIEF DESCRIPTION OF THE DRAWINGS

The foregoing and other objects, features, and advantages of the present invention, as well as the invention itself, will be more fully understood from the following description of various embodiments when read together with the accompanying drawings in which:

FIG. 1 presents an embodiment of a prior art system for communicating data between a server and a remote client;

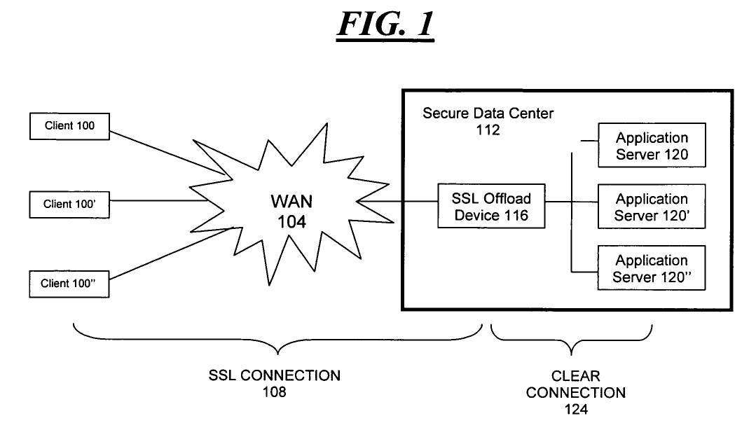

FIG. 2 presents another embodiment of a prior art system for communicating data between a server and a remote client;

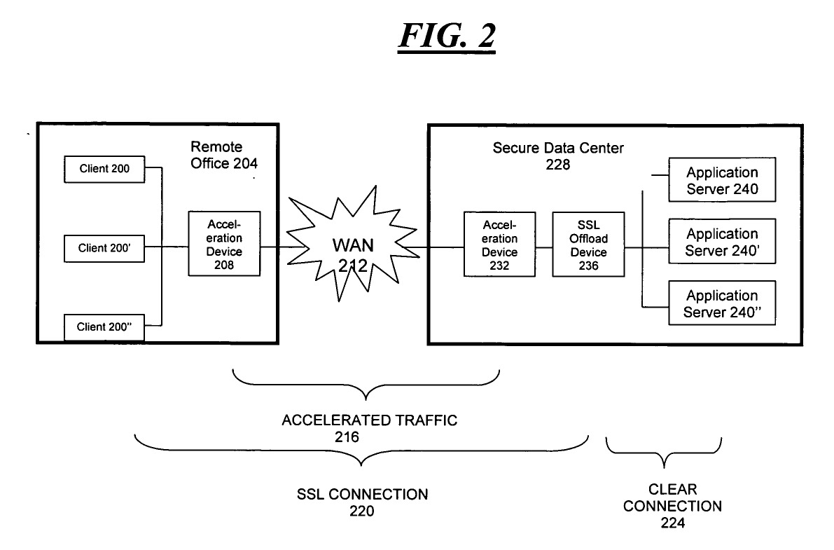

FIG. 3 presents still another embodiment of a prior art system for communicating data between a server and a remote client;

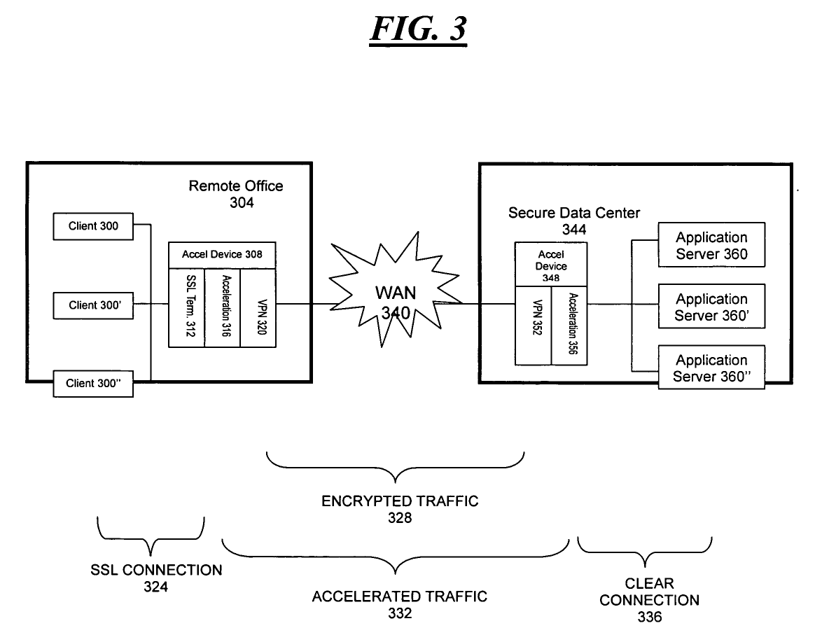

FIG. 4 presents an embodiment of a system for the communication of data in accord with an embodiment of the present invention; and

FIG. 5 presents the message flow for the communication of data in accord with an embodiment of the present invention.

### DETAILED DESCRIPTION OF THE INVENTION

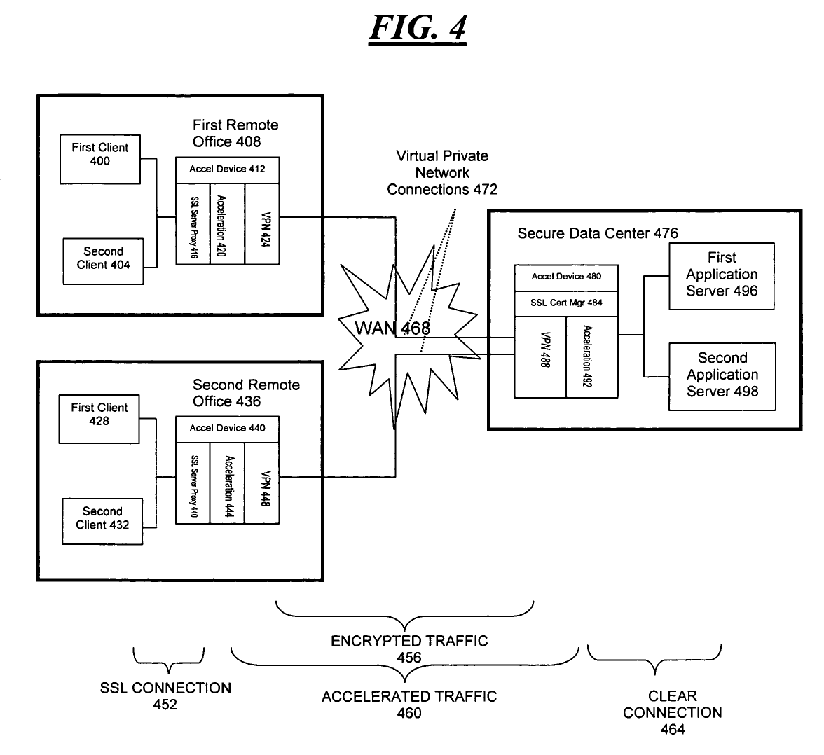

FIG. 4 shows one embodiment of a system in accord with the present invention. An acceleration device 480 is located in a secure data center 476, along with first and second application servers 496, 498. Another acceleration device 412 is located in a first remote office 408, along with first and second client computers 400, 404. Still another acceleration device 440 is located in a second remote office 436, along with first and second client computers 428, 432. Within the data center acceleration device 480, there exist, among others, the functions of SSL Certificate Manager 484, VPN 488, and acceleration 492. Similarly, within the remote office acceleration devices 412, 440, there exist respectively, among others, the functions of SSL Server Proxy 416, 440; acceleration 420, 444; and VPN 424, 448.

In such a system, an SSL connection 452 initiated by an SSL Client function residing on the first client computer 400 and directed toward the first application server 496 is instead processed by the acceleration device 412 located in the first remote office 408. More specifically, the SSL Server Proxy 416 within the first remote office acceleration device 412 operates in concert with the SSL Certificate Manager 484 within the data center acceleration device 480, as described above, to terminate the SSL connection 452 from the SSL Client. In doing so, data passing between the first client computer 400 and the first application server 496 in transit through both acceleration devices 412, 480, is made available to the acceleration functions in clear (non-encrypted) form. These functions may then apply any of various conventional data-reduction techniques to the traffic data to improve network and application performance. Furthermore, as shown in FIG. 4, the traffic between the first remote office 408 and the data center 476 is carried over virtual private network connections 472 as implemented by the VPN functions 488, 424 within the acceleration devices 480, 412. Traffic passing between the data center acceleration device 480 and the first application server 496 is shown transmitted over clear connections 464, though SSL connections alternatively may be used.

With continued reference to FIG. 4, SSL connection traffic passing between (a) the first client computer 400 in the first remote office 408 and the second application server 498 in the data center 476, (b) the second client computer 404 in the first remote office 408 and the first 496 and second 498 application servers in the data center 476, and (c) the first and second client computers 428, 432 in the second remote office 436 and the first and second application servers 496, 498 in the data center 476 may be processed by the acceleration devices 480, 440 as described above.

The motivation for placing the server-side SSL function (in the form of the SSL Server Proxy) in the remote office, as shown in FIG. 4, is to allow the acceleration function (within the acceleration devices) to have access to clear traffic data. However, even in the absence of traffic acceleration, systems may still benefit from distributing the server-side SSL function to the remote office. More specifically, in considering the motivation and approaches for SSL offload systems discussed earlier, it should be recognized that a system for distributed, rather than centralized, SSL offload has benefit with respect to system growth and scalability because the majority of server-side SSL processing is associated with the SSL Server Proxy (located in the remote office) and not the SSL Certificate Manager (located in the central data center). Therefore, additional SSL demand (driven by the addition of remote offices and remote office clients) can be accommodated by adding or upgrading remote office SSL offload devices with little or no impact on central data center resources. This enables a more incremental and scalable growth model as compared to centralized SSL offload systems. Such a distributed SSL offload system is identical to that shown in FIG. 4, except that no acceleration function is included in the remote office or data center devices.

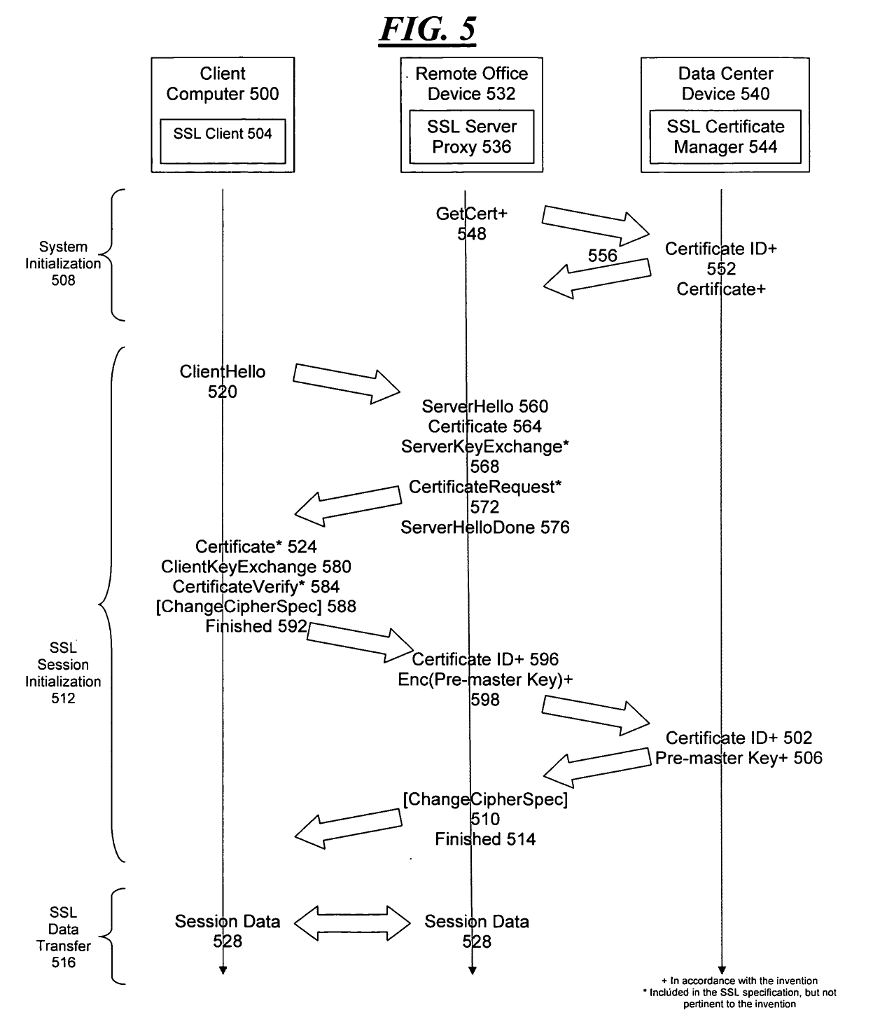

FIG. 5 shows the message flow between an SSL Client 504 (a functional component of a client computer), an SSL Server Proxy 536 (a functional component of a remote office device), and an SSL Certificate Manager 544 (a functional component of a data center device) in accord with an embodiment of the present invention utilizing SSL. SSL (i.e., TLS) protocol usage and message structures are known to the art and described, for example, in RFC 2246, The TLS Protocol Version 1.0.

Referring to FIG. 5, upon system startup or periodically thereafter, the SSL Server Proxy 536 sends a GetCert 548 message to the SSL Certificate Manager 544. The purpose of this message is to retrieve certificates and their related information for any application servers on whose behalf the SSL Server Proxy 536 should act. The SSL Certificate Manager 544 responds with a list of tuples, each tuple comprising: <Certificate ID, HostAddress, SSLPort, Certificate>552. Upon receiving this response, the SSL Server Proxy 536 caches this information for subsequent use as described below.

In general, certificates are not retained for long periods within the SSL Server Proxy 536 and instead are periodically refreshed via this GetCert message—response exchange 556. Alternatively, other schemes may be used for conveying the necessary information from the SSL Certificate Manager 544 to the SSL Server Proxy 536. For instance, Certificate ID, HostAddress, and SSLPort may be sent to the SSL Server Proxy 536 during system configuration and stored there in non-volatile memory. Certificates alone may be sent later via the GetCert message—response exchange 556 and cached temporarily.

Still referring to FIG. 5, the SSL Client 504 initiates an SSL session 508 by sending a ClientHello message 520 to the SSL Server (which in this case means the SSL Server Proxy 536). The SSL Server Proxy 536 responds by sending a ServerHello message 560 and, optionally, a certificate 564. According to the negotiated cipher suite, it may also send ServerKeyExchange 568 or CertificateRequest 572 messages. In the case where a certificate 564 is sent, the certificate 564 is associated with the HostAddress and SSLPort of the IP packet carrying the ClientHello 520 message. Following these messages, the SSL Server Proxy 536 sends a ServerHelloDone 576 message to the SSL Client 504.

Still referring to FIG. 5, the SSL Client 504, upon receiving the ServerHello message 560 and certificate 564 from the SSL Server Proxy 536, and subsequently verifying the certificate as described earlier, responds by sending a ClientKeyExchange message 580 to the SSL Server Proxy 536. The ClientKeyExchange message 580 contains the pre-master key, encrypted in the public key contained in the certificate. According to the negotiated cipher suite, the SSL Client 504 may also send its own certificate 524 or CertificateVerify message 584. Following these messages, the SSL Client 504 derives the various session keys from the pre-master key and random seed material (from the ‘hello’ messages). It then performs a ChangeCipherSpec operation 588, which begins the symmetric encryption and decryption of subsequent session data. Finally, the SSL Client sends a Finished message 592 to the SSL Server Proxy 536.

Upon receiving the ClientKeyExchange message 580, the SSL Server Proxy 536 sends to the SSL Certificate Manager 544 the Certificate ID 596 of the certificate 564 (which it sent to the SSL Client 504 and thus whose public key was used by the SSL Client 504 to encrypt the pre-master key), along with the encrypted pre-master key 598 from the ClientKeyExchange message 580. Upon receiving this information, the SSL Certificate Manager 544 decrypts the pre-master key using the private key associated with the Certificate ID 502 and sends the (clear) pre-master key 506 back to the SSL Server Proxy 536. An intervening VPN will ensure the privacy of the pre-master key during this transmission.

Upon receiving the pre-master key 506 from the SSL Certificate Manager 544, the SSL Server Proxy 536 derives the various session keys from the pre-master key and random seed material (from the ‘hello’ messages). It performs a ChangeCipherSpec operation 510 that begins the symmetric encryption and decryption of subsequent session data 528, and then sends a Finished message 514 to the SSL Client 504. Finally, session data 528 is encrypted and decrypted by the SSL Client 504 and SSL Server Proxy 536.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of securely communicating data between a server and a remote client computer, the method comprising:
a. providing an SSL server proxy, and a certificate manager comprising a decryption facility;
b. establishing a secure socket layer (SSL) connection between the client computer and the server utilizing communications between the SSL server proxy and the certificate manager; and
c. conducting a SSL communication session between the client computer and the server via the SSL server proxy.

2. The method of claim 1 wherein the SSL server proxy decrypts client-originated messages to the server.

3. The method of claim 2 wherein the SSL server proxy decrypts without further involvement from the certificate manager.

4. The method of claim 1 wherein the SSL server proxy encrypts server-originated messages to the client.

5. The method of claim 4 wherein the SSL server proxy encrypts without further involvement from the certificate manager.

6. The method of claim 1 wherein the SSL server proxy is co-located with the client computer.

7. The method of claim 1 wherein the decryption facility utilizes a key.

8. The method of claim 7 wherein the key is a private key and the certificate manager performs all operations using the private key so as to exclude the client computer and the SSL server proxy from access thereto.

9. The method of claim 1 further comprising causing the SSL server proxy to terminate the SSL connection with the client computer and perform data reduction on unencrypted data traffic outside the SSL connection.

10. The method of claim 9 wherein the reduced data traffic is exchanged via a virtual private network.

11. A system for facilitating secure communication of data between a server and a remote client computer, the system comprising:
a certificate manager comprising a decryption facility;
a secure socket layer (SSL) server proxy;
a connector for establishing an SSL connection between the client computer and the server via the SSL server proxy and the certificate manager using the decryption facility;
and
a transceiver for conducting a SSL communication session between the client computer and the server via the SSL server proxy.

12. The system of claim 11 wherein the SSL server proxy decrypts client-originated messages to the server.

13. The system of claim 12 wherein the SSL server proxy decrypts without further involvement from the certificate manager.

14. The system of claim 11 wherein the SSL server proxy encrypts server-originated messages to the client.

15. The system of claim 14 wherein the SSL server proxy encrypts without further involvement from the certificate manager.

16. The system of claim 11 wherein the SSL server proxy is co-located with the client computer.

17. The system of claim 11 wherein the decryption facility utilizes a key.

18. The system of claim 17 wherein the key is a private key and the certificate manager performs all operations using the private key so as to exclude the client computer and the SSL server proxy from access thereto.

19. The system of claim 11 further comprising an accelerator that causes the SSL server proxy to terminate the SSL connection to the client computer, and performs data reduction on unencrypted data traffic outside the SSL connection.

20. The system of claim 19 wherein the reduced data traffic is exchanged via a virtual private network.
